(19) United States
(12) Patent Application Publication
(10) Pub. No.: US 2016/0187742 A1
(43) Pub. Date: Jun. 30, 2016

(54) DISPLAY DEVICE

(71) Applicant: InnoLux Corporation, Miao-Li County (TW)

(72) Inventor: Wei-Lin LIU, Miao-Li County (TW)

(21) Appl. No.: 14/972,470

(22) Filed: Dec. 17, 2015

(30) Foreign Application Priority Data
Dec. 25, 2014 (TW) 103145428

(51) Int. Cl. G02F 1/1343

(52) U.S. Cl. CPC G02F 1/134309; G02F 2001/134318

(57) ABSTRACT

A display device comprising a first scan line and a second scan line disposed adjacently on a first substrate; a first data line and a second data line disposed on the first substrate and intersected with the first and second scan lines to define an area; a first pixel electrode disposed in the area and electrically connected to the first data line; a second pixel electrode, wherein the first or second data line is disposed between the first and second pixel electrodes; and a patterned common electrode including a first region and a second region disposed correspondingly above and electrically isolated from the first and second pixel electrodes, respectively; and the first and second regions are connected to each other and disposed symmetrically to each other with respect to a direction perpendicular to the first scan line.

### CROSS REFERENCE TO RELATED APPLICATION

This application claims the benefits of the Taiwan Patent Application Serial Number 103145428, filed on Dec. 25, 2014, the subject matter of which is incorporated herein by reference.

### BACKGROUND OF THE INVENTION

1. Field of the Invention

The present invention relates to a display device, and more particularly, to a display device having improved transmission rate, aperture ratio, and efficiency of liquid crystals.

2. Description of Related Art

As the display technology advances, the development of the trend of the devices is toward being small, thin, and light-weighted. Accordingly, the display device dominating the market has been changed from a cathode ray tube to a liquid crystal display device. The liquid crystal display device can be applied in many fields. For example, mobile phones, notebook computers, cameras, video cameras, music players, portable navigation devices, televisions, and so forth in daily use are often equipped with liquid crystal display devices. In recent years, display devices with touch panels have been more widely used in daily life.

Currently, the technology of liquid crystal display device is about to mature. However, various manufacturers still make efforts in the development of display devices with high optical performance to satisfy the display quality demanded by customers. In particular, transmission rate is one of the most important parameters of the display device. For example, panel with high-level performance is also demanded in the automotive industry. Thus, in addition to complying the requirement of the viewing angles of the automotive display panel, and the transmission rate and the contrast ratios of both the left and right viewing angles must be improved as well.

Thereby, in order to improve the properties of the viewing angles, to meet the requirement for better contrast, as well as to increase the aperture ratio and efficiency of liquid crystals, a display device having improved optical performance is still needed in the hope to offer consumers a better display quality.

### SUMMARY OF THE INVENTION

One object of the present invention is to provide a display device with improvements in the optical performance such as transmission rate, aperture ratio, efficiency of liquid crystals, and the like.

To achieve the object, the display device according to the present invention includes a first scan line and a second scan line disposed adjacently on a first substrate; a first data line and a second data line disposed on the first substrate and intersected with the first scan line and the second scan line to define an area; a first pixel electrode disposed in the area and electrically connected to the first data line; a second pixel electrode, wherein the first data line or the second data line is disposed between the first pixel electrode and the second pixel electrode; and a patterned common electrode including a first region and a second region, wherein the first region is disposed correspondingly above and electrically isolated from the first pixel electrode, the second region is disposed correspondingly above and electrically isolated from the second pixel electrode, and the first region and the second region are connected to each other and disposed symmetrically to each other with respect to a direction perpendicular to the first scan line.

In the one of the embodiment, each of the first region and the second region may include a plurality of stripe portions. Among them, at least one of the stripe portions and an extended direction of the scan line may form an included angle. The included angle may range from 5 degrees to 20 degrees, and preferably, from 5 degrees to 10 degrees. At least one of the stripe portions may have an extension portion at one of its end. Preferably, both of the ends of the stripe portions may have extension portions. The extension portion and the stripe portion may form an included angle in a range from 100 degrees to 170 degrees, and preferably, from 120 degrees to 160 degrees. The extension portion and a direction parallel to the extended direction of the first scan line may form an included angle in a range from 20 degrees to 70 degrees, and preferably, from 30 degrees to 60 degrees. The extension portion of the first region may be connected to the extension portion of the second region. The extension portion may partially cover the first data line or the second data line.

In the one of the embodiment, the first region may include a first unit and a second unit. Each of the first unit and the second unit includes a plurality of stripe portions. The first unit and the second unit are partially symmetrical to each other with respect to a direction parallel or perpendicular to the extended direction of the first scan line.

In the one of the embodiment, there is a symmetrical axis between the first unit and the second unit, and a distance between the symmetrical axis and the first unit is substantially equal to a distance between the symmetrical axis and the second scan line.

In the one of the embodiment, the stripe portions of the first unit may be arranged in a first direction, and the stripe portions of the second unit may be arranged in a second direction. The first direction and the second direction form an included angle in a range from 10 degrees to 30 degrees, and preferably, from 10 degrees to 20 degrees.

In the one of the embodiment, the first region includes a first unit and a second unit. Each of the first unit and the second unit includes a plurality of stripe portions. At least one of the stripe portions of the first unit are arranged in a first direction. At least one of the stripe portions of the second unit are arranged in a second direction. The first direction and a direction perpendicular to the extended direction of the first scan line form a first included angle. The second direction and the direction perpendicular to the extended direction of the first scan line form a second included angle. The first included angle and the second included angle are substantially equal to each other.

In the one of the embodiment, the display device may further include a second substrate and a display media layer. The second substrate is disposed above the first substrate. The display media layer is disposed between the second substrate and the patterned common electrode. In particular, the display device is a fringe field switching (FFS) display device or an in-plane switching (IPS) display device.

In the one of the embodiment, the patterned common electrode may further includes a third unit, a symmetrical axis is above the first scan line or the second scan line along a direction of the first scan line or the second scan line substantially extended, and the third unit is at least partially symmetrical to the first unit with respect to the symmetry axis.

In the one of the embodiment, the patterned common electrode may further includes a fourth unit, and the fourth unit is at least partially symmetrical to the second unit with respect to the symmetry axis.

Accordingly, in the display device of one of the present embodiment, the patterned common electrode is disposed above the pixel electrode and has a specific pattern. Consequently, the occurrence of dark lines at the edge of the pixel electrode and the common electrode (that is, between adjacent pixels) can be mitigated. Therefore, the area of black matrix (BM) can be reduced and the transmission rate, aperture ratio, and efficiency of liquid crystals can be improved.

Other objects, advantages, and novel features of the invention will become more apparent from the following detailed description when taken in conjunction with the accompanying drawings.

### BRIEF DESCRIPTION OF THE DRAWINGS

FIG. 1A is a schematic diagram illustrating a portion of a display device according to one embodiment of the present invention;

FIG. 1B is a schematic diagram illustrating a display device according to one embodiment of the present invention;

FIG. 2 is a schematic top view illustrating the patterned common electrode as shown in FIG. 1A;

FIG. 3 is a partially enlarged view of FIG. 2;

FIG. 4 is a schematic top view illustrating the patterned common electrode of a display device according to another embodiment of the present invention, which may be illustrated in a similar way as FIG. lA ; and

FIG. 5 is a partially enlarged view of FIG. 4.

### DETAILED DESCRIPTION OF THE PREFERRED EMBODIMENT

The present invention will be further described by the following embodiments in detail. It will be apparent to those skilled in the art to understand other advantages and functions of the present invention in view of the content disclosed herein. The present invention may also be used or applied in other different embodiments. Modifications and variations of the present invention may be made in the light of different viewpoints and applications without departing from the spirit of the present invention.

### Embodiment 1

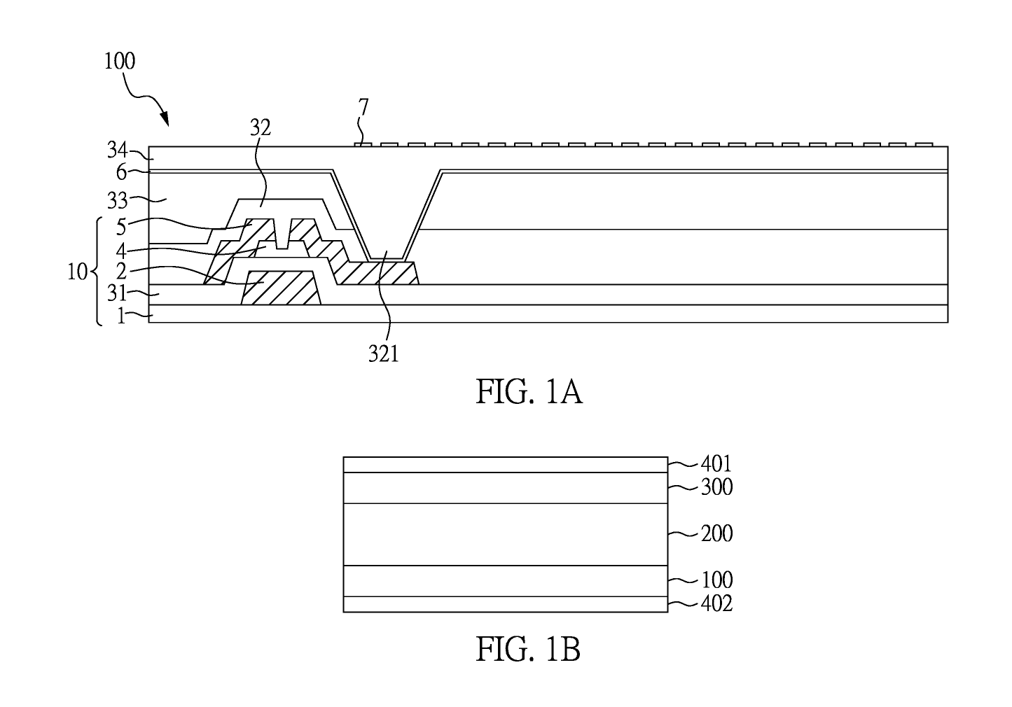

FIG. 1A is a schematic diagram illustrating a portion of a display device according to the one of the embodiment of the present invention. The display device includes a substrate 1; a first metal layer 2 including a scan line disposed on the substrate 1; a first insulation layer 31 disposed on the first metal layer 2; a semiconductor layer 4 disposed on the first insulation layer 31; a second metal layer 5 including a data line disposed on the semiconductor layer 4 and electrically isolated from the first metal layer 2; a second insulation layer 32 and a third insulation layer 33 disposed on the second metal layer 5 sequentially, wherein an opening 321 is formed through the second insulation layer 32 and the third insulation layer 33 to expose a portion of the second metal layer 5; a pixel electrode 6 disposed on the third insulation layer 33 and in an area defined by two adjacent scan lines and two adjacent data lines, within the opening 321 of the second insulation layer 32 and the third insulation layer 33, and electrically connected to the data line of the second metal layer 5; and a patterned common electrode 7 disposed above the pixel electrode 6 and electrically isolated from the pixel electrode 6 by a fourth insulation layer 34 therebetween. The substrate 1, the first metal layer 2, the first insulation layer 31, the semiconductor layer 4, and the second metal layer 5 form a thin film transistor 10.

The display device mentioned in one of the embodiment of the present invention may be a fringe field switching (FFS) display device or an in-plane switching (IPS) display device, but it is not limited thereto. The thin film transistor 10 may be formed by a conventional thin film transistor manufacturing process, and hence, the formation is not described herein. Examples of the substrate 1 may include substrates generally used in the art, such as glass substrate, plastic substrate, silicon substrate, ceramic substrate, and the like. Furthermore, examples of the material of the first metal layer 2 and the second metal layer 5 may respectively include conductive materials generally used in the art, such as metal, alloy, metal oxide, or electrode materials frequently used in other art, wherein metal material is preferred, but it is not limited thereto. If desirable, a composite electrode of transparent electrode and semi-transparent electrode, such as a composite electrode of TCO and platinum-thin-film electrode, may be used. The pixel electrode 6 may be a plate electrode layer or patterned electrode layer generally used in the art. The material of the pixel electrode 6 and the patterned common electrode 7 may be the transparent conductive material generally used in the art, for example, metal oxide transparent conductive material, such as ITO, IZO, and the like. For the semiconductor layer 4, oxide semiconductor material, such as indium gallium zinc oxide (IGZO), indium tin zinc oxide (ITZO), other metal oxide semiconductor, and the like, generally used in the art can be used. In addition, material for the first insulation layer 31, the second insulation layer 32, the third insulation layer 33, and the four insulation layer 34 may be material for passivation layers generally used in the art, for example, silicon nitride (SiNₓ), silicon oxide (SiOₓ), or a combination thereof. The material can be selected according to leveling properties, capacitance matching properties, and other conditions. However, the present embodiment is not limited thereto.

To emphasize the features of the present invention, elements which are often disposed in a general display device are not shown in FIG. 1A. With reference to FIG. 1B, in this case, when the display device according the present embodiment is a liquid crystal display (LCD) device, the display device includes a structural unit 100 as shown in FIG. 1A, a display media layer 200, a second substrate 300 including black matrix and color filter, upper and lower polarizers 401 and 402, and so forth. In addition, the display device may be applied to any electronic device known in the art, for example, display devices, mobile phones, cameras, video cameras, music players, portable navigation devices, televisions and so forth.

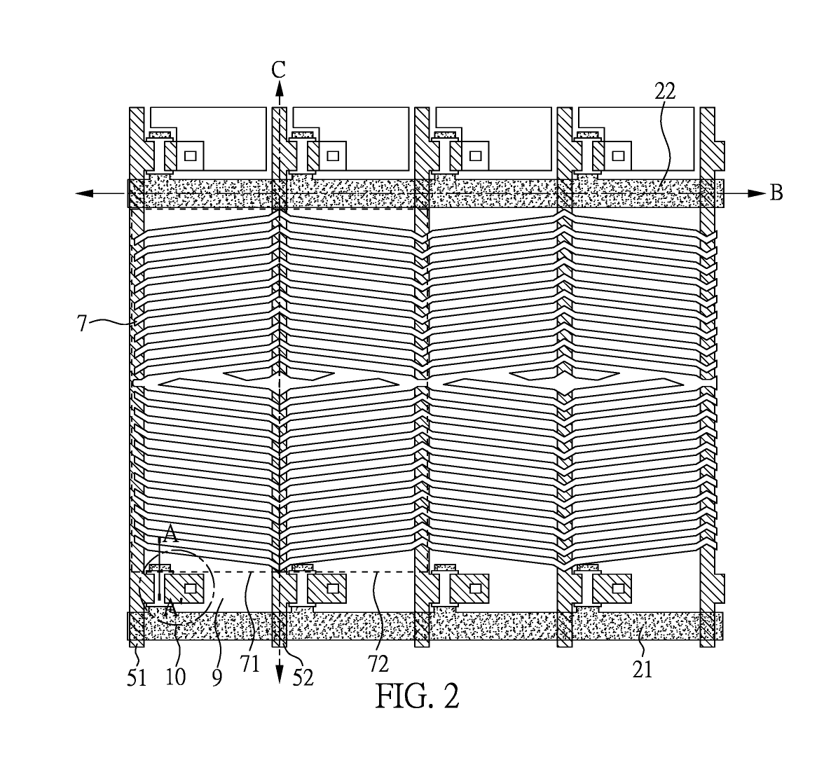

FIG. 2 is a schematic top view illustrating the patterned common electrode 7 shown in FIG. 1A. FIG. 1A is a cross-sectional view along the cross-section line A-A′ shown in FIG. 2. In FIG. 2, the pixel electrode 6 under the patterned common electrode 7 is not shown in order to illustrate the relative position of the patterned common electrode 7 more clearly. With reference to FIG. 1A and FIG. 2 together, the first metal layer 2 includes a first scan line 21 and a second scan line 22. The second metal layer 5 includes a first data line 51 and a second data line 52 intersected with the first scan line 21 and the second scan line 22, to define an area 9. The extended direction of the first scan line 21 is represented by the letter “B”. The extended direction of the first data line 51 or the second data line 52 is represented by the letter “C”. The pixel electrode 6 under the patterned common electrode 7 may include a first pixel electrode and a second pixel electrode. The first pixel electrode is disposed in the area 9 and electrically connected to the first data line 51. The first data line 51 or the second data line 52 is disposed between the first pixel electrode and the second pixel electrode, and, accordingly, in this embodiment, the second pixel electrode may be electrically connected to the second data line 52. The patterned common electrode 7 includes a first region 71 and a second region 72. The first region 71 is disposed correspondingly above the first pixel electrode and electrically isolated from the first pixel electrode. The second region 72 is disposed correspondingly above the second pixel electrode and electrically isolated from the second pixel electrode. The first region 71 and the second region 72 are connected to each other and symmetrical to each other with respect to a direction perpendicular to the extended direction B of the first scan line 21. It is worth mentioning that in another embodiment the first scan line 21 or the second scan line 22 may be a polyline. In such situation, the first region 71 and the second region 72 are connected to each other and symmetrical to each other with respect to a direction perpendicular to a substantially extended direction B of the first scan line 21 or the second scan line 22. In another embodiment, the first region 71 and the second region 72 are connected to each other and symmetrical to each other with respect to a direction parallel to the extended direction C of the first data line 51 and the second data line 52. Likewise, in another embodiment, the first data line 51 or the second data line 52 may be a polyline. Accordingly, the first region 71 and the second region 72 are connected to each other and symmetrical to each other with respect to a direction parallel to a substantially extended direction C of the first data line 51 or the second data line 52.

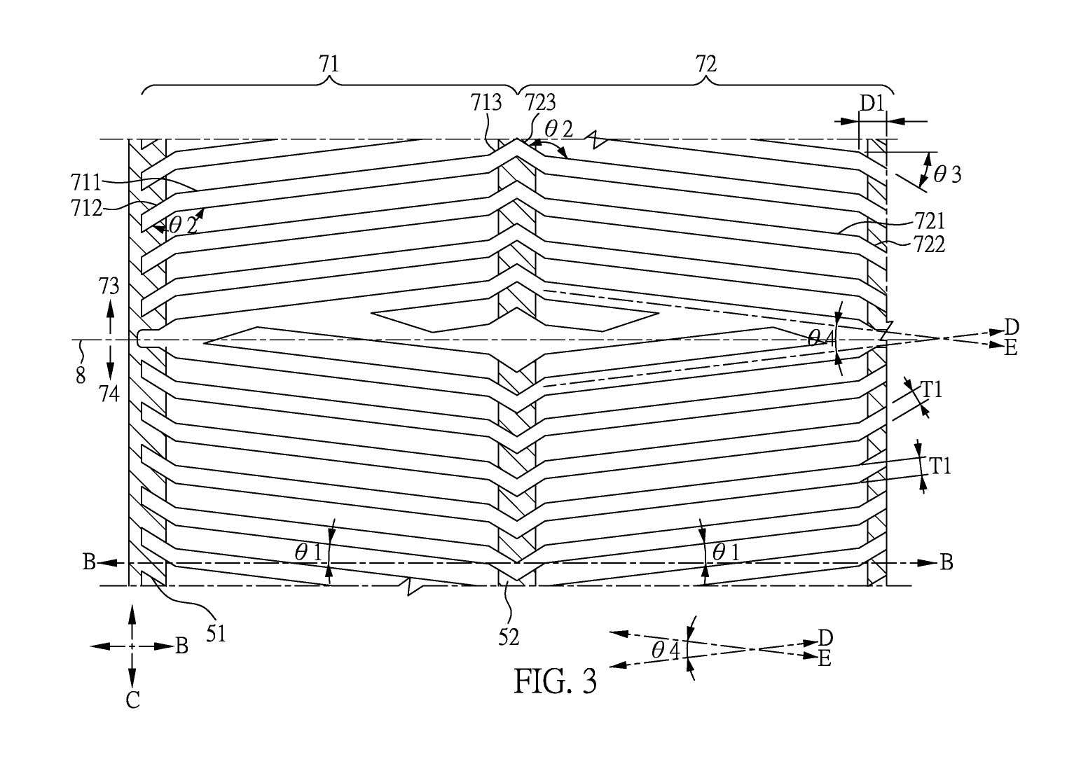

With reference to FIG. 3, FIG. 3 shows a partially enlarged view of FIG. 2. As FIG. 3 shows, the first region 71 and the second region 72 may include a plurality of stripe portions 711 and 721, respectively. Each of the stripe portions 711 and 721 and the extended direction B of the first scan line 21 may form an included angle θ1 in a range from 5 degrees to 20 degrees, and preferably, from 5 degrees to 10 degrees. When the included angle is larger than 20 degree, the dark lines will develop outwards, i.e. the dark lines will develop toward a direction farther from the first data line 51 or the second data line 52, resulting in the decrease of the transmission rate of the display device.

Furthermore, in one of the embodiment of the invention, the ends of the stripe portions 711 and 721 may have extension portions 712, 713, 722, and 723, respectively. The extension portions 712, 713, 722, 723 and the stripe portions 711, 721 may form an included angle θ2 in a range from 100 degrees to 170 degrees, and preferably, from 120 degrees to 160 degrees. When the included angle is greater than 170 degrees, the inhibition of the occurrence of dark lines by the extension portions 712, 713, 722, and 723 is poor. When the included angle is less than 100 degrees, the occurrence of dark lines develops towards the stripe portions, resulting in the decrease of the transmission rate. In the embodiment, the included angle θ2 is about 155 degrees. And preferably, as shown in FIG. 3, each end of the stripe portions 711 has the extension portions 712 and 713 and each end of the stripe portions 721 has the extension portions 722 and 723. The extension portions 713 and 723 are connected to each other. Accordingly, the occurrence of the dark lines can be effectively inhibited and the balance between the right viewing angle and the left viewing angle is improved.

Furthermore, each of the extension portions 712, 713, 722, and 723 and the extended direction B may form an included angle θ3 in a range from 20 degrees to 70 degrees, and preferably, from 30 degrees to 60 degrees.

In addition, the extension portion 713 of the first region 71 may be connected to the extension portion 723 of the second region 72. The extension portions 712, 713, 722, and 723 may partially cover the first data line 51 or the second data line 52. The sizes of the extension portions 712, 713, 722, and 723 are not limited. In the embodiment, the lengths D1 of the extension portions 712, 713, 722, and 723 along the extended direction B of the first scan line 21 are preferably in a range from 3 to 5 μm, so as to mitigate the occurrence of dark lines, and the widths T1 of the stripe portions 711 and 721 and the extension portions 712, 713, 722, and 723 are preferably in a range from 2 to 5 μm, but it is not limited thereto. The term “width” represents a straight-line distance, i.e. the shortest distance, between the two sides of the stripe portion or the extension portion.

In addition, the first region 71 may include a first unit 73 and a second unit 74. The first unit 73 and the second unit 74 are at least partially symmetrical to each other with respect to a direction parallel to the extended direction B of the first scan line 21.

In addition, the first unit 73 and the second unit 74 may be disposed apart from each other with a symmetrical axis 8 therebetween. The symmetrical axis 8 is a virtual line parallel to the extended direction B of the first scan line 21.Distances from the symmetrical axis 8 to the adjacent first scan line 21 and second scan line 22 are substantially equal. Accordingly, not only the effect of the balance between the right viewing angle and the left viewing angle can be achieved, but also a better balance between the upper and the lower viewing angles can be achieved as well. Therefore, users at any positions may have good viewing angles.

In addition, the stripe portions 711 of the first unit 73 may be arranged in a first direction D, and the stripe portions 711 of the second unit 74 may be arranged in a second direction E. The first direction D and the second direction E form an included angle θ4 in a range from 10 degrees to 30 degrees, and preferably, from 10 degrees to 20 degrees.

Accordingly, in the display device according to the present embodiment, since the patterned common electrode is disposed above the pixel electrode and has a particular pattern, and thus, the dark lines, which conventionally occur at the edges of the pixel electrode and the common electrode, especially between the first region 71 and the second region 72, can be remarkably reduced. Therefore, the area for disposing black matrix (BM) can be reduced, and the transmission rate, aperture ratio, and efficiency of liquid crystals can be improved.

### Embodiment 2

The display device of Embodiment 2 is substantially similar to that of Embodiment 1, except that the pattern of the patterned common electrode is different from that of Embodiment 1. For clearer presentation, redundant description is not repeated. Those ordinarily skilled in the art would understand that the similar parts in Embodiment 1 may be applicable to those in Embodiment 2.

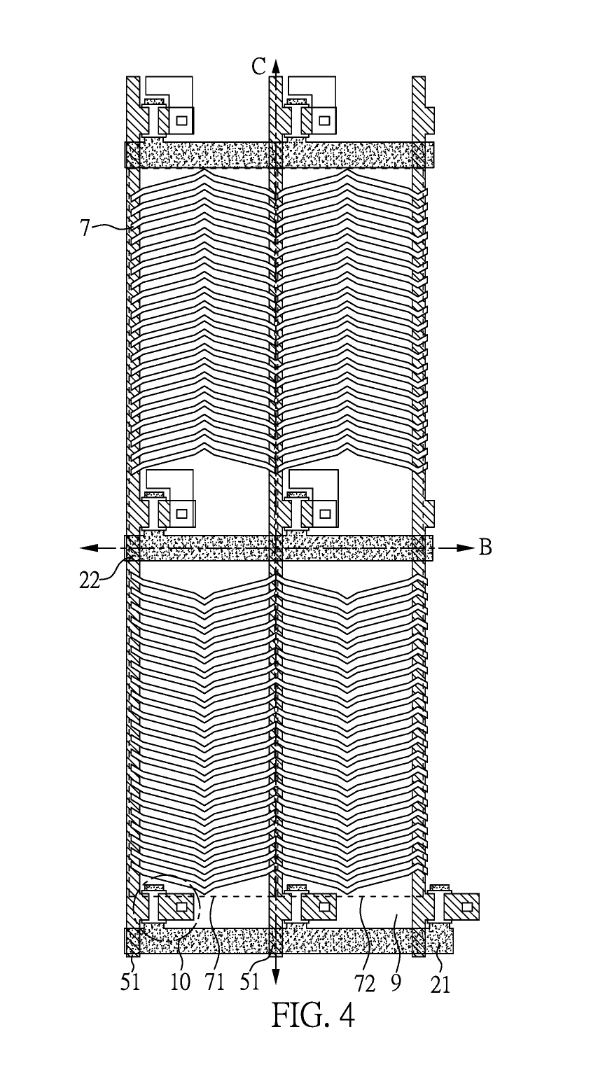

In FIG. 4, the pixel electrode under the patterned common electrode 7 is not shown in order to illustrate the relative position of the patterned common electrode 7 more clearly. With reference to FIG. 1A and FIG. 4 together, the first metal layer 2 includes a first scan line 21 and a second scan line 22. The second metal layer 5 includes a first data line 51 and a second data line 52, which intersected with the first scan line 21 and the second scan line 22, to define an area 9. The extended direction of the first scan line 21 is represented by the letter “B”. The extended direction of the first data line 51 is represented by the letter “C”. The patterned common electrode 7 includes a first region 71 and a second region 72. The first region 71 and the second region 72 are connected to each other and symmetrical to each other with respect to a direction perpendicular to the extended direction B of the first scan line 21.

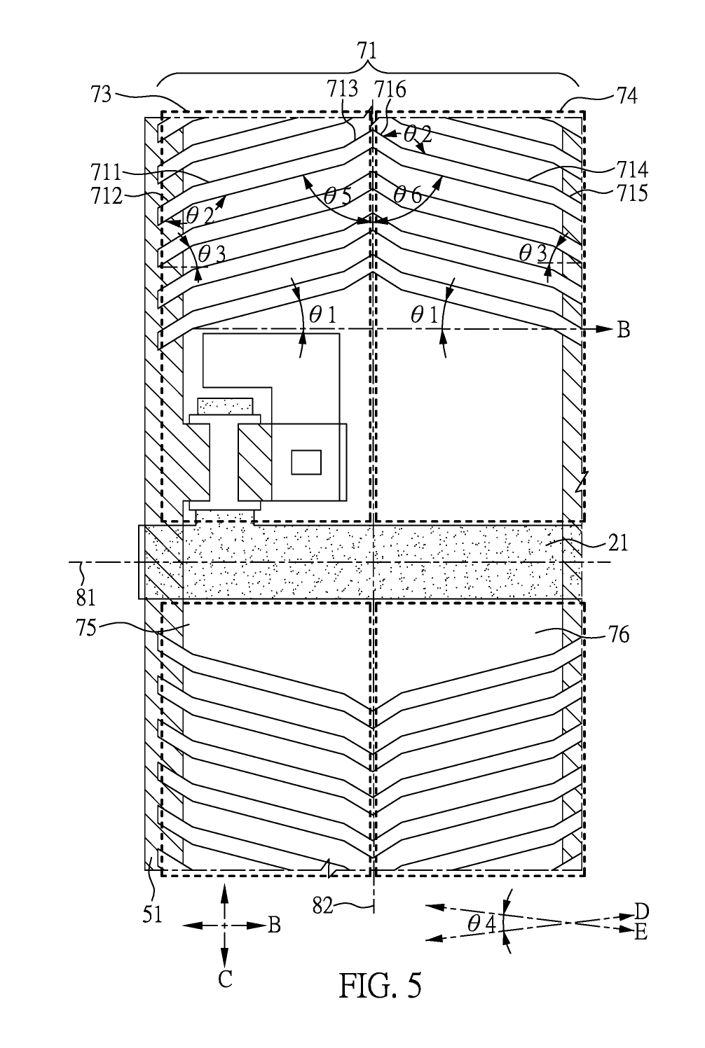

With reference to FIG. 5, FIG. 5 shows a partially enlarged view of FIG. 4. As FIG. 5 shows, the first region 71 may include a first unit 73 and a second unit 74. The first unit 73 and the second unit 74 may include a plurality of stripe portions 711 and 714, respectively. Each of the stripe portions 711 and 714 and a direction parallel to the extended direction B of the first scan line 21 may form an included angle θ1 in a range of from 5 degrees to 20 degrees, and preferably, from 5 degrees to 10 degrees. When the included angle is larger than 20 degrees, the dark lines will develop outwards, resulting in the decrease of the transmission rate of the display device. The stripe portions 711 of the first unit 73 may be arranged in a first direction D. The stripe portions 711 and a direction perpendicular to the extended direction B of the first scan line 21 form an included angle θ5. The stripe portions 714 of the second unit 74 may be arranged in a second direction E. The stripe portions 714 and a direction perpendicular to the extended direction B of the first scan line 21 form an included angle θ6. The included angle θ5 is substantially equal to the included angle θ6, which means that the first unit 73 and the second unit 74 are symmetrical to each other with respect to a direction perpendicular to the extended direction B of the first scan line 21.

Furthermore, the ends of the stripe portions 711 and 714 may have extension portions 712, 713, 715, and 716, respectively. The extension portions 713 and 716 are connected to each other. The extension portions 712, 713, 715, 716 and the stripe portions 711, 714 may form an included angle θ2 in a range from 100 degrees to 170 degrees, and preferably, from 120 degrees to 160 degrees. When the included angle is greater than 170 degrees, the inhibition of the occurrence of dark lines by the extension portions 712, 713, 715, and 716 is poor. When the included angle is less than 100 degrees, the occurrence of dark lines develop towards the stripe portions, resulting in the decrease of the transmission rate. In the embodiment, the included angle θ2 is about 155 degrees.

Furthermore, the extension portions 712, 713, 715, and 716 and a direction parallel to the extended direction B of the first scan line 21 may form an included angle θ3 in a range from 20 degrees to 70 degrees, and preferably, from 30 degrees to 60 degrees. In addition, the extension portions 712 and 715 in the first region 71 may be connected to the extension portions in an adjacent region, respectively. The extension portions 712 and 715 may partially cover the first data line 51 and the second data line 52.

Furthermore, the first unit 73 and the second unit 74, disposed at a side of a first symmetrical axis 81, may be symmetrical to a third unit 75 and a fourth unit 76 disposed at another side of the first symmetrical axis 81, respectively, with respect to the first symmetrical axis 81. The first symmetrical axis 81 is parallel to the extended direction B of the first scan line 21. The first symmetrical axis 81 may correspond to the first scan line 21, that is, a position of the first symmetrical axis 81 may be above the first scan line 21 from a top view. In other words, the third unit 75 is at least partially symmetrical to the first unit 73 with respect to the first symmetry axis 81; and the fourth unit 76 is at least partially symmetrical to the second unit 74 with respect to the first symmetry axis 81.

Although the present invention has been explained in relation to its preferred embodiment, it is to be understood that many other possible modifications and variations can be made without departing from the spirit and scope of the invention as hereinafter claimed.

What is claimed is:

1. A display device, comprising:
a first scan line and a second scan line disposed adjacently on a first substrate;
a first data line and a second data line disposed on the first substrate and intersected with the first scan line and the second scan line to define an area;
a first pixel electrode disposed in the area and electrically connected to the first data line;
a second pixel electrode, wherein the first data line or the second data line is disposed between the first pixel electrode and the second pixel electrode; and
a patterned common electrode including a first region and a second region, wherein the first region is disposed correspondingly above and electrically isolated from the first pixel electrode, the second region is disposed correspondingly above and electrically isolated from the second pixel electrode, and the first region and the second region are connected to each other and disposed symmetrically to each other with respect to a direction perpendicular to the first scan line.

2. The display device as claimed in claim 1, wherein each of the first region and the second region includes a plurality of stripe portions, at least one of the stripe portions has an extension portion at an end thereof, and the extension portion and the stripe portion form an included angle in a range from 100 degrees to 170 degrees.

3. The display device as claimed in claim 1, wherein each of the first region and the second region includes a plurality of stripe portions, at least one of the stripe portions has an extension part at an end thereof, and the extension portion and a direction parallel to the extended direction of the first scan line form an included angle in a range from 20 degrees to 70 degrees.

4. The display device as claimed in claim 1, wherein each of the first region and the second region includes a plurality of stripe portions, at least one of the stripe portions has an extension portion at an end thereof, and the extension portions of the first region and the extension portions of the second region are connected to each other.

5. The display device as claimed in claim 1, wherein each of the first region and the second region includes a plurality of stripe portions, at least one of the stripe portions has an extension portion at an end thereof, and the extension portion partially covers the first data line or the second data line.

6. The display device as claimed in claim 1, wherein the first region includes a first unit and a second unit, each of the first unit and the second unit includes a plurality of stripe portions, and the first unit and the second unit are partially symmetrical to each other with respect to a direction parallel to the extended direction of the first scan line.

7. The display device as claimed in claim 6, there is a symmetrical axis between the first unit and the second unit, wherein a distance between the symmetrical axis and the first unit is substantially equal to a distance between the symmetrical axis and the second scan line.

8. The display device as claimed in claim 7, wherein the stripe portions of the first unit are arranged in a first direction, the stripe portions of the second unit are arranged in a second direction, and the first direction and the second direction form an included angle in a range from 10 degrees to 30 degrees.

9. The display device as claimed in claim 1, wherein the first region includes a first unit and a second unit, each of the first unit and the second unit includes a plurality of stripe portions, the stripe portions of the first unit are arranged in a first direction, the stripe portions of the second unit are arranged in a second direction, the first direction and a direction perpendicular to the extended direction of the first scan line form a first included angle, the second direction and a direction perpendicular to the extended direction of the first scan line form a second included angle, and the first included angle and the second included angle are substantially equal to each other.

10. The display device as claimed in claim 1, further comprising: a second substrate disposed on the first substrate; a display media layer disposed between the second substrate and the patterned common electrode, wherein the display device is a fringe field switching (FFS) display device or an in-plane switching (IPS) display device.

11. The display device as claimed in claim 1, wherein the first region includes a first unit and a second unit, each of the first unit and the second unit includes a plurality of stripe portions, and the first unit and the second unit are partially symmetrical to each other with respect to a direction perpendicular to the extended direction of the first scan line.

12. The display device as claimed in claim 11, wherein the patterned common electrode further includes a third unit, a symmetrical axis is above the first scan line or the second scan line along a direction of the first scan line or the second scan line substantially extended, and the third unit is at least partially symmetrical to the first unit with respect to the symmetry axis.

13. The display device as claimed in claim 12, wherein the patterned common electrode further includes a fourth unit, and the fourth unit is at least partially symmetrical to the second unit with respect to the symmetry axis.
